(19) United States
(12) Patent Application Publication
(10) Pub. No.: US 2010/0257022 A1
(43) Pub. Date: Oct. 7, 2010

(54) Finding Similar Campaigns for Internet Advertisement Targeting

(75) Inventors: Jinlin Wang, Mountain View, CA (US); Xia Wan, Saratogo, CA (US); Weiguo Liu, Dublin, CA (US); Shi Zhong, Austin, TX (US)

Correspondence Address: Weaver Austin Villeneuve & Sampson - Yahoo!, P.O. BOX 70250, OAKLAND, CA, 94612-0250, US

(73) Assignee: Yahoo! Inc.

(21) Appl. No.: 12/419,923

(22) Filed: Apr. 7, 2009

(51) Int. Cl. G06Q 30/00; G06F 17/30; G06F 17/27

(52) U.S. Cl. 705/10; 704/9; 705/14.41; 705/14.73

(57) ABSTRACT

Disclosed are methods and apparatus for analyzing campaigns in order to identify similar campaigns are disclosed. In one embodiment, an ad campaign associated with an advertiser is identified. Ad campaign information associated with ad campaigns previously booked by an online publisher is analyzed to identify one or more of the ad campaigns previously booked by the online publisher that are similar to the ad campaign. The ad campaign information for each of the ad campaigns identifies one or more products of the online publisher. The ad campaign information may be processed by applying natural language processing (NLP) to at least a portion of the ad campaign information associated with the ad campaigns previously booked by the online publisher. At least one of the products of the online publisher to recommend to the advertiser are ascertained from the ad campaign information for the one or more ad campaigns previously booked by the online publisher that are similar to the ad campaign.

### BACKGROUND OF THE INVENTION

The disclosure relates generally to computer implemented and automatic analysis of campaigns for Internet advertisements.

When a user visits a web page of a web content provider (i.e., online publisher), the web page often displays some advertisements together with its contents. An advertisement that is displayed via the Internet is often referred to as a banner advertisement. A banner advertisement typically includes a link to a website of the advertiser. When a user clicks on the banner advertisement (e.g., link in the banner advertisement), the user may be redirected to the website advertised in the banner advertisement. A banner advertisement may be placed at a variety of locations of a web page including at the top (i.e., the North), the right hand side (i.e., the East), and the bottom (i.e., the South) of the web page. In order to execute an advertisement campaign, advertisers typically pay online publishers to place their advertisements on a web page. In the widely used pay-per-click model, each advertiser is typically charged only when her ad receives a click. In another popular pricing model, an advertiser is charged based upon the number of impressions that are guaranteed.

Advertisers generally request that a minimum number of impressions (i.e., views) be guaranteed. In addition, advertisers may also specify additional conditions that are to be satisfied by the online publisher of the ads. For example, the advertisers may specify a desired target profile of users who are to receive a particular advertisement. As another example, advertisers may also specify a particular position in which an advertisement is to be placed. A publisher will therefore typically attempt to maximize their profits (e.g., by achieving high click-through-rates), while satisfying the requirements of the advertisers.

There are many choices available to advertisers when placing their advertisements with an online publisher. Unfortunately, evaluating advertisement campaigns can be a time-consuming and cumbersome process.

### SUMMARY OF THE INVENTION

Methods and apparatus for analyzing campaigns for Internet advertisements are disclosed. An ad campaign may involve the publishing of one or more advertisements. Specifically, an advertisement campaign may be published using one or more advertising products available from an online publisher.

An advertising product (i.e., product) available for purchase from an online publisher may be defined by a variety of attributes (i.e., booking information). For example, booking information may specify the web page and/or position within a web page where the ad is going to appear. The booking information may also include or identify text, image(s), audio and/or video content of the ad. A product may be identified or defined by booking information such as a business category, campaign name, tag(s) and/or keyword(s) to describe the ad. A product may be further defined by a target user profile. The target user profile may indicate geographical, demographic, and/or behavioral attributes of desired viewers of an advertisement. The days and/or time of the day the ad is to appear may also be regarded as part of the target profile. The booking information may also include the number of impressions to be provided in association with the target profile, maximum daily budget of the advertiser and/or total budget of the advertiser. Each piece of booking information can be regarded as assigning a value to a feature of an advertisement product.

A product may be identified by booking information such as that described above. Product booking information associated with a set of products used by an ad campaign may be referred to as campaign information. Similarly all booking information of an advertiser may be referred to as advertiser information.

An online publisher may wish to recommend various features or products to an advertiser. In order to ascertain one or more products (or features) to recommend to the advertiser, it may be desirable to identify similar ad campaigns. Through analyzing results of executing similar campaigns, the online publisher may recommend products (or features) based on the experience of other similar ad campaigns.

In one embodiment, an ad campaign associated with an advertiser is identified. Ad campaign information associated with ad campaigns previously booked by an online publisher is analyzed to identify one or more of the ad campaigns previously booked by the online publisher that are similar to the ad campaign. The ad campaign information for each of the ad campaigns identifies one or more products of the online publisher. The ad campaign information may be processed by applying natural language processing (NLP) to at least a portion of the ad campaign information associated with the ad campaigns previously booked by the online publisher. At least one of the products of the online publisher to recommend to the advertiser may then be ascertained from the ad campaign information for the one or more ad campaigns previously booked by the online publisher that are similar to the ad campaign.

An online publisher may also wish to ascertain the effectiveness of various campaigns or products that have previously been booked and executed. The online publisher may ascertain the effectiveness of a particular ad campaign by comparing the results of the ad campaign with results of similar ad campaigns. Where other products of similar ad campaigns have been more effective, the online publisher may recommend products used in these effective products of the similar ad campaigns. The products that are recommended may identify specific web page(s) and/or locations, as well as user geographic, demographic and/or behavioral targets.

In accordance with another embodiment, an ad campaign associated with an advertiser is identified. Ad campaign information associated with ad campaigns previously booked by an online publisher may be processed to identify one or more of the ad campaigns previously booked by the online publisher that are similar to the ad campaign, wherein the ad campaigns previously booked by the online publisher include the ad campaign associated with the advertiser. The ad campaign information for each of the ad campaigns and the ad campaign information for the ad campaign may identify one or more products of the online publisher that correspond to that ad campaign. The ad campaign information may be processed by applying natural language processing (NLP) to at least a portion of the ad campaign information associated with the ad campaigns previously booked by the online publisher. Using the ad campaign information for the one or more ad campaigns previously booked by the online publisher that are similar to the ad campaign and the ad campaign information for the ad campaign, information indicating effectiveness of the ad campaign may be ascertained.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a block diagram illustrating an example system in which various embodiments may be implemented.

FIG. 2 is a diagram illustrating example user data that may be obtained or collected in accordance with various embodiments.

FIG. 3 is a diagram illustrating an example ad campaign.

FIG. 4 is a general process flow diagram illustrating an example method of identifying similar campaigns for Internet advertisement targeting.

FIG. 5 is a process flow diagram illustrating an example method of processing ad campaign information as shown at 404 of FIG. 4.

FIG. 6 is a simplified diagram of a network environment in which various embodiments may be implemented.

FIG. 7 illustrates an example computer system in which various embodiments may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

The disclosed embodiments may analyze ad campaigns for Internet advertising. In the example set forth below, a single ad server is illustrated for clarity. However, it is important to note that this example is merely illustrative. Accordingly, the disclosed embodiments may be implemented on any number of servers.

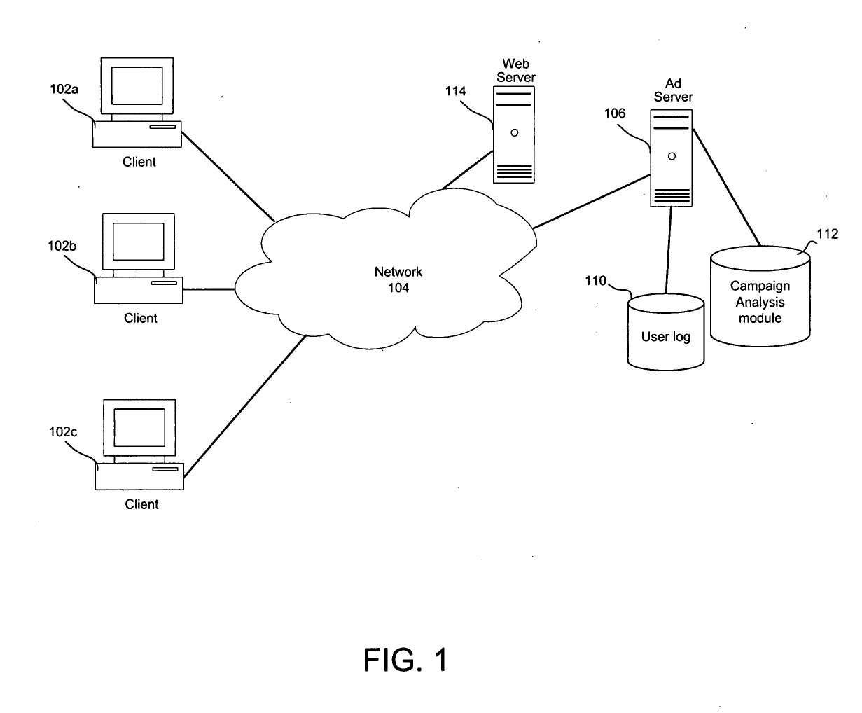

FIG. 1 illustrates an example network segment in which various embodiments of the invention may be implemented. As shown, a plurality of clients 102a, 102b, 102c may each receive an impression (i.e., view) of one or more advertisements upon accessing a web page via a web server 114, as will be described in further detail below. Advertisements may also be transmitted by an advertiser server (not shown) maintained by an advertiser (e.g., in the form of pop up windows). Alternatively, an advertisement may be transmitted to the clients 1021, 102b, 102c via electronic mail. The clients 102a, 102b, 102c may be coupled to the web server 114 via a network 104. The network 104 may take any suitable form, such as a wide area network or Internet and/or one or more local area networks (LAN's). The network 104 may include any suitable number and type of devices, e.g., routers and switches, for forwarding search or web object requests from each client to the search or web application and search or web results back to the requesting clients.

An online publisher may implement a search application. A search application generally allows a user (human or automated entity) to search for information that is accessible via network 104 and related to a search query including one or more search terms. The search terms may be entered by a user in any manner. For example, the search application may present a web page having any input feature to the client (e.g., on the client's device) so the client can enter a query including one or more search term(s). In a specific implementation, the search application presents an input box into which a user may type a query including any number of search terms. Embodiments of the present invention may be employed with respect to any search application. Example search applications include Yahoo! Search, Google, Altavista, Ask Jeeves, etc.

As will be described in further detail below, an ad campaign may have one or more corresponding advertisements associated therewith that are delivered to users via one or more products available from the online publisher. When a user visits a web page, the system (e.g., ad server 106) may identify the best web advertisement to place in the web page. Information indicating whether the user clicks on the advertisement and/or purchases a product or service as a result of clicking on the advertisement may also be maintained, enabling a click-through rate and/or cost of conversion for the advertisement to be computed. By tracking the historical performance of an ad campaign, it is possible to ascertain the effectiveness of an ad campaign and/or product(s) used in the ad campaign.

Embodiments disclosed herein for ascertaining the effectiveness of a campaign, identifying similar campaigns, and/or recommending advertising products used in similar campaigns may be implemented via a Campaign Analysis module 112, which may be coupled to the ad server 106. The Campaign Analysis module 112 may access ad campaign information for ad campaigns that have previously been booked by the online publisher. The ad campaign information for various ad campaigns may be stored in an associated campaign management database (not shown). In order to ensure that the ad campaign information remains pertinent, the oldest campaign information may be purged periodically. For instance, it may be desirable to retain ad campaign information for a period of several months or years. The disclosed embodiments may be implemented via software and/or hardware.

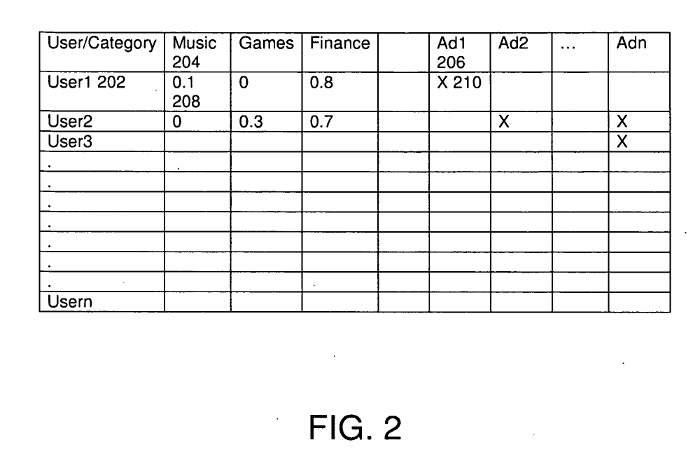

An ad server 106 (or servers) of the online publisher may have access to one or more user logs 110 (e.g., user databases) into which user information is retained. For example, the user logs 110 may be retained in one or more memories that are coupled to the ad server 106. Each time a user performs online activities such as clicking on an advertisement or purchasing goods or services, information regarding such activity or activities may be retained as user data in the user logs 110. For instance, the user data that is retained in the user logs 110 may indicate the identity of web sites visited, identity of ads that have been selected (e.g., clicked, on) and/or a timestamp. User data representing the activities of the users may be retained or summarized in the user logs 110 as scores. Additional user data such as demographic information (e.g., age and/or gender) and/or geographic information (e.g., zip code) may also be retained in the user logs 110. A user may be identified in the user logs 110 by a user ID (e.g., user account ID), information in a user cookie, etc. Example user data that may be stored in the user logs 110 will be described in further detail below with reference to FIG. 2. Where the online publisher supports a search engine (e.g., via the ad server 106 or a separate search server), information associated a search query, such as search term(s) of the search query, information indicating characteristics of search results that have been selected (e.g., clicked on) by the user, and/or associated timestamp may also be retained in the user logs 110.

When a user visits a web page, the system (e.g., ad server 106) may identify the best web advertisement to place in the web page. The ad server 106 may select an advertisement to deliver to the user. The disclosed embodiments may be implemented via software and/or hardware.

An online publisher (i.e., web publisher) will generally be responsible for delivering multiple advertisements via the Internet. A contract agreement associated with a particular advertisement may specify a minimum number of page views (i.e., impressions) to be delivered within a particular period of time. The web publisher is therefore responsible for providing the requested number of impressions for each advertisement.

An advertisement may include content which may be delivered via the Internet. The content typically includes text. However, it is important to note that an advertisement may include text, one or more images, video, and/or audio. An advertisement may also include one or more hypertext links, enabling a user to proceed with the purchase of a particular product or service.

The disclosed embodiments may also support the dynamic selection of advertisements to be provided to users. For instance, selected advertisement(s) may be provided to a user via the Internet. In one embodiment, when a user visits a web page via the Internet, the system may automatically select one or more advertisement(s) to be served to the user. The publisher may then automatically provide the selected advertisement(s) to the user.

In order to select advertisement(s) to be provided to a user, the system may maintain user data for a plurality of users. The user data may indicate prior behavior of the plurality of users. The prior behavior of each of the plurality of users may be monitored with respect to a plurality of categories. For instance, each of the plurality of categories may identify a type of Internet content contained in web sites or web pages that may be visited by a user. In addition, the system may monitor and track those ads that are clicked on by each user. The system may also monitor and track purchases that are completed once an ad has been clicked on by the user when possible.

FIG. 2 is a table illustrating example user data (e.g., behavioral targeting data) that may be collected in accordance with various embodiments. In this example, the user data indicates for each of a plurality of users 202, prior behavior with respect to a plurality of categories 204 and a subset of a plurality of ads 206 previously clicked on (e.g., during a particular period of time). In this example, the categories 204 include Music, Games, and Finance. However, it is important to note that these categories 204 are merely illustrative, and therefore these particular categories may or may not exist in the user logs 110. The user data indicating prior behavior of the users 202 may be ascertained from the user logs 110, as well as other sources of user data (e.g., user account information, cookie, purchase history, etc.).

For each of the users 202, a score 208 representing the user's prior behavior may be stored in association with each of the categories 204. The score 208 may indicate a level of interest of the user 202 in the corresponding category 204 based upon prior Internet activity of the user 202. Thus, the score 208 may indicate the likelihood of the user 202 to click on an ad containing content that falls within that particular category 204. The Internet activity may include those web sites or web pages visited or clicked on by the user. The amount of time spent by the user on the web sites or web pages, the frequency and/or recency, and/or other parameters of the visit may also be factored into the user's score 208. The user's online commercial activities (e.g., in association with various categories 204) can be particularly interesting and factored into the score 208 with a higher weight. The user's commercial activities may include clicking on advertisements, filling out a purchase leading form (e.g., in association with a particular advertisement) and/or purchasing goods or services (e.g., via a particular web site or in association with a particular advertisement). Data obtained from a search engine may also be incorporated into the user's score 208. Each score 208 may be a numerical value. In this example, the scores 208 are values between 0 and 1. However, the scores 208 may be represented using other value ranges.

The user data may also indicate a subset of the advertisements 206 that have been clicked on by the user 202 (e.g., during a particular period of time). In this example, an “X” indicates that the user 202 clicked on the corresponding advertisement 206, as shown at 210. Specifically, as shown in this example, User1 has clicked on Ad1, User2 has clicked on Ad2 and Adn, and User3 has clicked on Adn.

Although not shown in this example, the user data associated with each of the plurality of users may indicate a geographical location, age, and/or sex of each of the plurality of users. The user data may also indicate a purchase history of each of the plurality of users.

In this example, the user data is represented by a table. However, it is important to note that the user data may be stored in a variety of formats.

The user data may be collected over a period of time (e.g., days, weeks, or months). Since the user data may become outdated, the system may purge the oldest user data. For instance, the system may maintain the user data for a period of several days. The system may also implement a time decay function to weight an older event less than a fresh event.

Given historical user data, finding an optimal delivery plan is possible. Specifically, one can maximize the probability of a user clicking on an advertisement based upon previously collected user data. For a popular web page, the statistics of daily visitors' categories can be quite stable. In other words, tomorrow's visitors are generally statistically quite similar to today's visitors. Therefore, today's optimal solution can be used as a base to deliver tomorrow's advertisements. Accordingly, once the user data has been collected, the system may generate a statistical model from the user data.

For a popular ad space, the number of page viewers and therefore the number of impressions on a given day can be very large. In this case, we can partition the historical data by time of the day, such as morning, afternoon, and/or evening. In other words, user data that is collected may be categorized and partitioned accordingly. Not only does this make the problem size much more manageable, but the factor of time of day may be build into the campaign analysis.

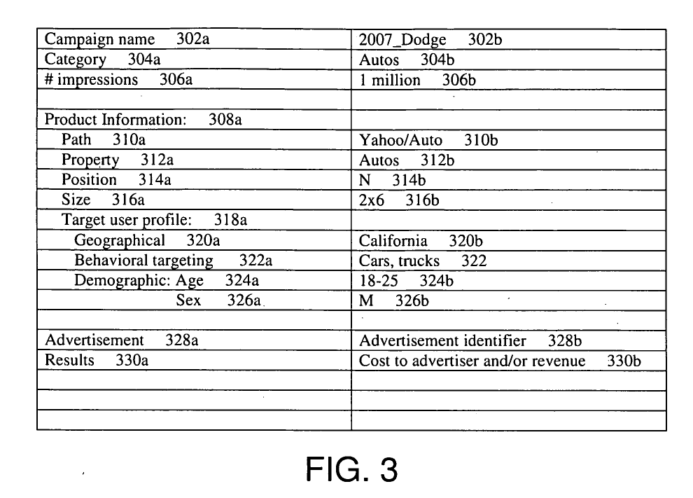

FIG. 3 is a diagram illustrating an example ad campaign. Each ad campaign may be defined by corresponding campaign information. As shown in this example, the ad campaign information associated with a campaign may be represented by a data structure such as a table. However, campaign information may be stored in a variety of formats.

The ad campaign information for an ad campaign may indicate the subject matter of the ad campaign. For instance, the ad campaign information may include a name 302a of the ad campaign. In this example, the name of the campaign is 2007_Dodge 302b. The ad campaign information may also include a category 304a of the ad campaign (and corresponding advertisement(s). For instance, the category 304a may indicate one or more of the categories used to categorize user behavior, as described above with reference to FIG. 2. In this example, the category is Autos 304b.

An advertiser typically requires the online publisher to guarantee a minimum number of impressions. Thus, the ad campaign information may indicate the guaranteed number of impressions 306a. In this example, the number of impressions is 1 million, as shown at 306b.

The ad campaign information may also identify the product(s) sold by the online publisher to the advertiser in order to publish the advertisement(s) for this ad campaign. In general, booking information associated with an advertising product may identify the “advertising space” being sold, as well as the target profile of users who would be viewing the “advertising space.”

The product(s) may each be identified by corresponding product information 308a, which may also be referred to as booking information. The product information 308a may identify a path 310a on the Internet via which an advertisement for the ad campaign is to be published. In this example, the path 310a is a uniform resource locator (URL), Yahoo/Auto 310b. The product information 308a may also identify a property 312a. In this example, the property 312a is a URL property, Autos 312b, which identifies a URL (e.g., web page) via which the advertisement is to be published. The product information 308a may also indicate one or more position(s) 314a (e.g., within the web page) via which the advertisement is to be published. Positions are often referred to in terms of North, South, East, and West. In this example, the position 314b is North (N). The product information 308a may also indicate a size 316a of the advertisement to be published. In this example, the size 316b is 2×6.

The product information 308a may also identify a target user profile 318a of the desired users who are to receive the advertisement(s) for the corresponding campaign. For instance, the target user profile 318a may indicate geographical attribute(s) 320a, behavioral targeting attribute(s) 322a, and/or demographics such as age 324a or sex 326a. In this example, the geographical attribute(s) 320b indicate that the desired target audience is in California, the behavioral targeting attribute(s) 322b indicate that the desired target audience is interested in cars and/or trucks, and possibly visits sites on the Internet that are related to cars and/or trucks. The desired target audience is also between 18-25 and male (M), as shown at 324b and 326b, respectively.

The ad campaign may have one or more associated advertisements to be delivered via the product(s) identified in the ad campaign information. Thus, the ad campaign information may also identify an advertisement 328a to be published for this ad campaign. For instance, the advertisement 328a may be identified at 328b via a file name or other identifier. Moreover, the ad campaign information may also indicate the content (e.g., text) in the advertisement 328b, enabling this content to be used in the campaign analysis.

The ad campaign information may also indicate the results 330a of publishing the ad(s) associated with the campaign. The results 330b may be represented in a variety of ways. Moreover, the results 330b may include a variety of numerical values indicating how well the ad campaign performed for the corresponding advertiser. For instance, the results 330b may indicate the revenue of the ad campaign, the total cost of the ad campaign, the number of impressions received, the number of clicks received, the click-through rate of the advertisement, the cost per click for the advertiser, and/or the cost per conversion to a sale. The cost per conversion may be obtained by tracking orders submitted by users who click on the advertisement.

At least a portion of the ad campaign information may be stored for each ad campaign when the ad campaign is booked by the online publisher. The ad campaign information may also be updated periodically or upon satisfying the requirements of the advertiser for the ad campaign. For instance, the ad campaign information may be updated to indicate the results 330b of the ad campaign. Thus, in one embodiment, the system analyzes the ad campaign information for campaigns after the ad campaigns are completed (e.g., after the ad(s) have been published via the product(s) identified in the ad campaign information and the requirements of the advertisers for the campaigns have been satisfied).

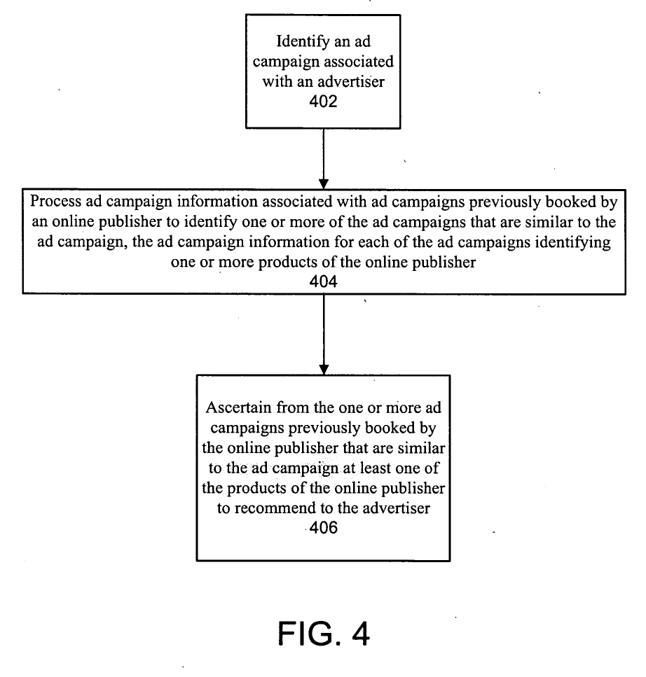

FIG. 4 is a general process flow diagram illustrating an example method of identifying similar campaigns for Internet advertisement targeting. The system may identify an ad campaign associated with an advertiser at 402. Specifically, the advertiser may ask for recommendations of product(s) for a particular ad campaign prior to booking the ad campaign (and agreeing on a price for the ad campaign). Thus, this ad campaign may be a proposed ad campaign that has not previously been booked by the online publisher. The ad campaign may therefore be identified by ad campaign information that has been provided by the advertiser. The ad campaign information may include or consist of a set of words. Since the ad campaign has not been booked, the ad campaign information for the ad campaign may not identify information for one or more products and/or number of impressions. Alternatively, the ad campaign may be one of the ad campaigns previously booked by the online publisher. In other words, the system may analyze the effectiveness of an ad campaign that has already been executed by comparing the ad campaign with similar campaigns that have also been executed.

The system may process ad campaign information associated with ad campaigns previously booked by an online publisher to identify one or more of the ad campaigns previously booked by the online publisher that are similar to the ad campaign at 404. The ad campaign information for each of the ad campaigns may identify one or more products of the online publisher, as described above with reference to FIG. 3. In one embodiment, the system may process the ad campaign information by applying natural language processing (NLP) to at least a portion of the ad campaign information associated with ad campaigns previously booked by the online publisher. The system may also process the ad campaign information for the ad campaign of the advertiser. Specifically, the system may compare at least a portion of the ad campaign information associated with the ad campaigns with at least a portion of ad campaign information associated with the ad campaign. This may be accomplished via a variety of algorithms, as will be described in further detail below.

The system may ascertain from the one or more ad campaigns previously booked by the online publisher that are similar to the ad campaign at least one of the products of the online publisher to recommend to the advertiser at 406. As described above, these products may be recommended in association with a proposed campaign, as well as in response to an ad campaign that has already been run (e.g., executed). The ad campaigns that have been booked may be associated with a plurality of advertisers. The plurality of advertisers for which the ad campaigns have already been booked may or may not include the advertiser for which the recommendations are being provided or the analysis is being performed.

The system may analyze results of publishing advertisements for the campaigns previously booked by the online publisher that are similar to the ad campaign in order to identify the product(s) of the online publisher to recommend to the advertiser. This analysis may include filtering out campaigns that are lowest performing (e.g., highest cost to the advertiser and/or yielding the lowest profits or revenues for the advertiser) based upon the results of the campaign, such as those described above with reference to FIG. 3. For instance, the system may select a subset of the ad campaigns previously booked by the online publisher that are similar to the ad campaign (e.g., according to cost or performance of the similar ad campaigns), and identify one or more products associated with the selected subset of the one or more ad campaigns. This enables the system to identify and recommend products that can provide an optimum result to the advertiser (e.g., low cost per click and/or low cost per conversion).

The product(s) that are recommended to the advertiser may be product(s) that have been implemented in the similar ad campaigns. However, those products that are recommended need not be the same products that have been used in the similar ad campaigns. Rather, various components of products implemented in the selected subset of similar ad campaigns (e.g., the more effective products) may be identified in order to recommend one or more products using at least a portion of these various components. These components may be identified by booking information such as that disclosed herein. For instance, components may include web page, position, target profile, etc.

Of course, rather than identify specific products to be recommended to the advertiser, the system may provide information that indicates the effectiveness of an ad campaign that has already been run (e.g., executed or published) in comparison to other similar ad campaigns. This information may further identify product(s) associated with other, more effective similar ad campaigns. Thus, the system may consider the result of the identified ad campaign of the advertiser (e.g., by comparing the result with the similar ad campaigns). In this manner, the system may monitor the performance of the various campaigns that the online publisher has booked. Accordingly, the ad campaign information may be continually adjusted and refined when additional campaigns are booked and run.

Information indicating effectiveness of an ad campaign, product feature(s) and/or recommended products may be provided to an advertiser via a variety of mediums. Specifically, the information may be printed, displayed and/or transmitted via a network. For instance, the information may be transmitted via electronic mail.

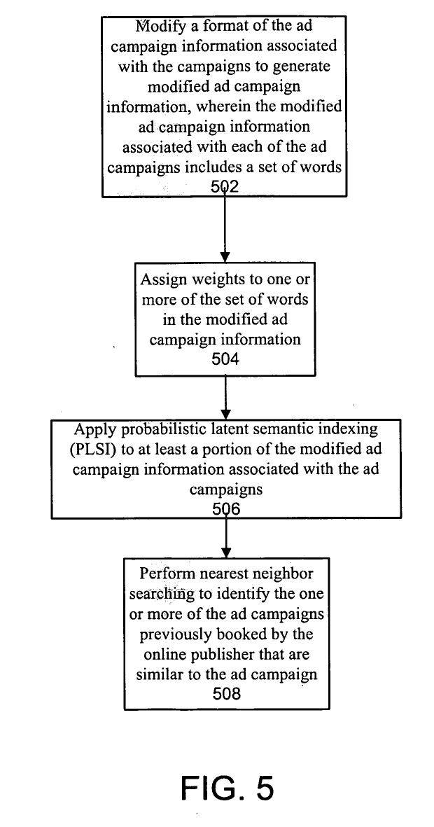

FIG. 5 is a process flow diagram illustrating an example method of processing ad campaign information as shown at 404 of FIG. 4. In one embodiment, before processing the ad campaign information, a format of the ad campaign information associated with the ad campaigns (and/or the ad campaign of the advertiser) may be modified to generate modified ad campaign information at 502 that can be processed by a NLP algorithm. For instance, where the ad campaign information for the ad campaigns (and/or the ad campaign of the advertiser) is represented in a table or other format, it may be desirable to parse the ad campaign information and convert the parsed ad campaign information to another format. The resulting modified ad campaign information for each of the ad campaigns (and/or the ad campaign of the advertiser) may include a set of words. This set of words may be referred to as a “bag of words” representation. This may be accomplished by “translating” at least a portion of the ad campaign information (e.g., numerical values, numerical ranges, and/or acronyms, etc.) in the ad campaign information to one or more words. For example, the age range “18-25” may be translated to “young.” Moreover, some of the ad campaign information may be eliminated or left untranslated during the generation of the modified ad campaign information. For instance, some fields of the ad campaign information may already be in text format. Thus, some words may not be translated. The resulting modified campaign information may consist of words (e.g., excluding numerical values), which may exclude acronyms or other “text” that may be difficult for a NLP algorithm to interpret. In one embodiment, the modified ad campaign information for one of the ad campaigns previously booked by the online publisher may be represented by a single line of a document (e.g., file). NLP may therefore be performed on the modified campaign information of the ad campaigns previously booked by the online publisher and/or the modified campaign information of the ad campaign of the advertiser (e.g., by performing NLP on the document).

Before performing NLP on the modified campaign information, the system may assign weights at 504 to one or more of the set of words in the modified ad campaign information for the ad campaigns (and/or the ad campaign of the advertiser) such that the modified ad campaign information includes the assigned weights. More specifically, because the set of words for a single ad campaign may include a small number of words, it may be desirable to assign a weight to one or more of the set of words for a campaign to give those words greater (or less) weight during the analysis of the set of words. These weights may be determined based upon a variety of factors, including the number of times a word is used in the set of words for the campaign or the number of times the word is used over all of the campaigns (e.g., in the document). As one example, for words that appear frequently (e.g., in campaign information for a large number of campaigns) or do not help to characterize the campaigns, the weight of the words may be down-weighted. For instance, if a word occurs in ad campaign information for all of the campaigns, it may be assigned a weight of zero. As another example, the weight associated with behavioral targeting words (e.g., categories) may be increased. Weights may be normalized for a campaign or advertiser to eliminate bias to higher spending campaigns or advertisers. A weighted set of words associated with an ad campaign may be referred to as a word vector.

In one embodiment, a base weight for a word may be the sum of revenues of all of the campaigns (e.g., lines) for which the word appears in the corresponding campaign information. For instance, if the word “finance” appears in two campaigns (e.g., two corresponding lines), with revenue $100,000 and $40,000, respectively, the word will be assigned a weight of $140,000. The “base weight” for a word may be increased or reduced based upon various factors such as those described above.

The system may apply NLP to the ad campaign information (e.g., modified campaign information) associated with the ad campaigns (and the ad campaign of the advertiser) using a variety of mechanisms or algorithms. The term natural language processing (NLP) may generally refer to a range of computational techniques for analyzing and/or representing text. Probabilistic latent semantic indexing (PLSI) is one of many computational techniques that may be used to perform NLP. PLSI is also known as probabilistic latent semantic analysis (PLSA). PLSI may be applied to the modified campaign information of the ad campaigns (and modified ad campaign information for the ad campaign of the advertiser) to ascertain a distance (e.g., divergence) of other ad campaigns from the ad campaign of the advertiser, which may be referred to as a “seed campaign.”

In one embodiment, the system applies PLSI at 506 to at least a portion of the ad campaign information (e.g., the modified ad campaign information) associated with the ad campaigns (and the ad campaign of the advertiser). This may be accomplished by applying PLSI to a document or file storing the modified ad information for the ad campaigns and the modified information for the ad campaign. Specifically, the PLSI algorithm may be applied to the weighted set of words (e.g., word vectors) for all of the ad campaigns that have been booked (and the identified ad campaign) in order to build a topic model. Using the topic model, the system may then derive a topical distribution for each of the ad campaigns (e.g., the identified ad campaign and the previously booked ad campaigns) in order to ascertain (e.g., measure) the distance between the seed campaign and each of the previously booked campaigns. The distance between two campaigns may be measured using a Kullback-Leibler (KL) divergence between the two corresponding topical distributions.

The system may perform nearest neighbor searching to identify the one or more of the ad campaigns previously booked by the online publisher that are similar to the ad campaign at 508. Specifically, the system may identify a pre-defined number of “nearest neighbors” by identifying those ad campaigns that are closest in distance to the ad campaign of the advertiser (i.e., seed campaign) based upon the distances calculated at step 506.

If each advertiser has a single ad campaign associated therewith, the disclosed embodiments may be used to compare the effectiveness of ad campaigns of the various advertisers. However, an advertiser may also simultaneously run multiple ad campaigns.

Although the disclosed embodiments assume that ad campaign information for campaigns of a plurality of advertisers is analyzed, these examples are merely illustrative. Thus, it may also be desirable to analyze ad campaigns associated with a single advertiser. Moreover, where ad campaigns identify multiple products, it may be desirable to apply NLP at the product or advertisement level, rather than at the campaign level. For instance, each line of a document may identify a different product that has been booked in association with an advertisement for an ad campaign.

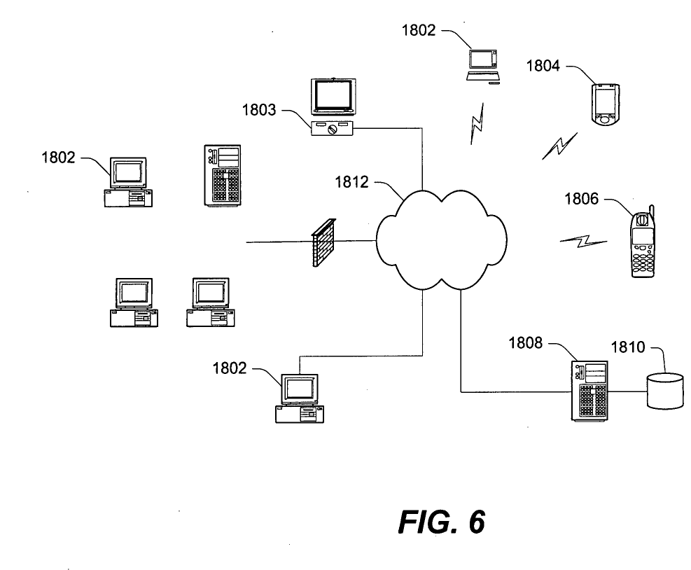

The disclosed embodiments may be employed to automatically analyze campaign information, identify similar campaigns, and/or recommend one or more products in any of a wide variety of computing contexts. For example, as illustrated in FIG. 6, implementations are contemplated in which users interact with a diverse network environment via any type of computer (e.g., desktop, laptop, tablet, etc.) 1802, media computing platforms 1803 (e.g., cable and satellite set top boxes and digital video recorders), handheld computing devices (e.g., PDAs) 1804, cell phones 1806, or any other type of computing or communication platform.

And according to various embodiments, input that is processed in accordance with the invention may be obtained using a wide variety of techniques. For example, a search query may be obtained from a user's interaction with a local application, web site or web-based application or service and may be accomplished using any of a variety of well known mechanisms for obtaining information from a user. However, it should be understood that such methods of obtaining input from a user are merely examples and that a search query may be obtained in many other ways.

User data may be collected and/or processed in order to analyze the effectiveness of campaigns and recommend products for use in similar campaigns in accordance with the disclosed embodiments in some centralized manner. This is represented in FIG. 6 by server 1808 and data store 1810 which, as will be understood, may correspond to multiple distributed devices and data stores. The invention may also be practiced in a wide variety of network environments (represented by network 1812) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. The campaign analysis and advertisement delivery apparatus and/or web browser of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store historical user data, advertisements, contract information including requested number of impressions, campaign information, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

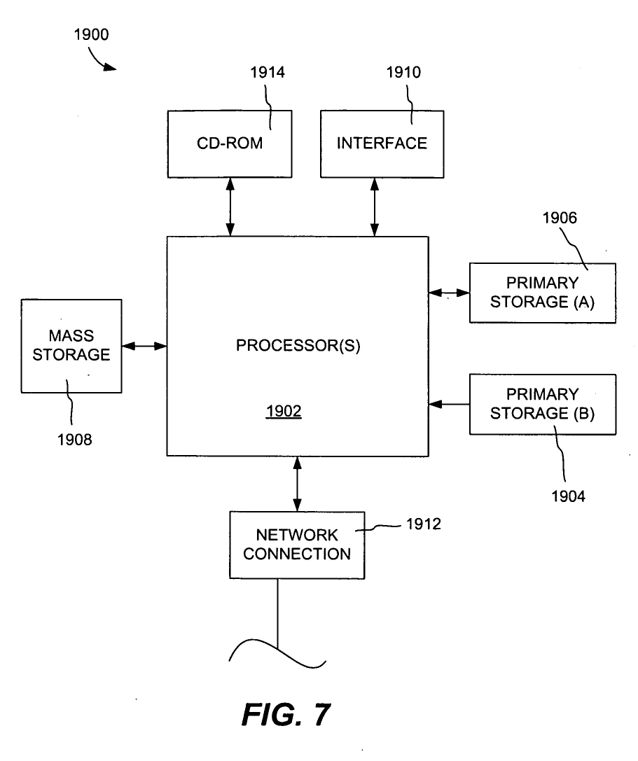

FIG. 7 illustrates a typical computer system that, when appropriately configured or designed, can serve as a system of this invention. The computer system 1900 includes any number of processors 1902 (also referred to as central processing units, or CPUs) that are coupled to storage devices including primary storage 1906 (typically a random access memory, or RAM), primary storage 1904 (typically a read only memory, or ROM). CPU 1902 may be of various types including microcontrollers and microprocessors such as programmable devices (e.g., CPLDs and FPGAs) and unprogrammable devices such as gate array ASICs or general purpose microprocessors. As is well known in the art, primary storage 1904 acts to transfer data and instructions uni-directionally to the CPU and primary storage 1906 is used typically to transfer data and instructions in a bi-directional manner. Both of these primary storage devices may include any suitable computer-readable media such as those described above. A mass storage device 1908 is also coupled bi-directionally to CPU 1902 and provides additional data storage capacity and may include any of the computer-readable media described above. Mass storage device 1908 may be used to store programs, data and the like and is typically a secondary storage medium such as a hard disk. It will be appreciated that the information retained within the mass storage device 1908, may, in appropriate cases, be incorporated in standard fashion as part of primary storage 1906 as virtual memory. A specific mass storage device such as a CD-ROM 1914 may also pass data uni-directionally to the CPU.

CPU 1902 may also be coupled to an interface 1910 that connects to one or more input/output devices such as such as video monitors, printers, track balls, mice, keyboards, microphones, displays such as touch-sensitive displays, transducer card readers, magnetic or paper tape readers, tablets, styluses, voice or handwriting recognizers, or other well-known input devices such as, of course, other computers. Finally, CPU 1902 optionally may be coupled to an external device such as a database, or a computer or telecommunications network using an external connection as shown generally at 1912. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. For instance, the various examples set forth refer to the recommendation of products. However, it is important to note that the embodiments may also be applied to recommend one or more product features. Therefore, the present embodiments are to be considered as illustrative and not restrictive and the invention is not to be limited to the details given herein, but may be modified within the scope and equivalents of the appended claims.

What is claimed is:

1. A method, comprising:
identifying an ad campaign associated with an advertiser as a seed campaign;
processing ad campaign information associated with ad campaigns previously booked by an online publisher to identify one or more of the ad campaigns previously booked by the online publisher that are similar to the seed campaign, the ad campaign information for each of the ad campaigns identifying one or more products of the online publisher, wherein processing the ad campaign information includes applying natural language processing (NLP) to at least a portion of the ad campaign information associated with the ad campaigns previously booked by the online publisher; and
ascertaining from the ad campaign information for the one or more ad campaigns previously booked by the online publisher that are similar to the ad campaign at least one of the products from the similar campaigns to recommend to the advertiser.

2. The method as recited in claim 1, wherein the steps of identifying, processing, and ascertaining are performed automatically by the online publisher.

3. The method as recited in claim 1, wherein ascertaining comprises:
analyzing results of publishing advertisements for the one or more ad campaigns previously booked by the online publisher that are similar to the ad campaign in order to identify the at least one of the products of the online publisher to recommend to the advertiser.

4. The method as recited in claim 3, further comprising:
selecting a subset of the one or more ad campaigns previously booked by the online publisher that are similar to the ad campaign according to cost and historical performance associated with each of the subset of the one or more ad campaigns; and
identifying one or more products associated with the selected subset of the one or more ad campaigns.

5. The method as recited in claim 1, wherein the ad campaign is one of the ad campaigns previously booked by the online publisher.

6. The method as recited in claim 1, wherein the ad campaign is a proposed ad campaign that has not previously been booked by the online publisher, wherein the ad campaign has associated ad campaign information.

7. The method as recited in claim 1, wherein the ad campaign information of each of the ad campaigns indicates subject matter of a corresponding one of the ad campaigns.

8. The method as recited in claim 7, wherein the ad campaign information of each of the ad campaigns indicates a target profile of users to receive an advertisement associated with a corresponding one of the ad campaigns.

9. The method as recited in claim 1, each of the products of the online publisher indicating a web page, position, and size within the web page at which an advertisement can be displayed.

10. The method as recited in claim 9, each of the products further indicating a target profile of users to receive an advertisement associated with a corresponding one of the ad campaigns.

11. The method as recited in claim 1, wherein each of the ad campaigns has one or more associated advertisements that have been delivered via the products identified in the corresponding ad campaign information.

12. The method as recited in claim 1, further comprising:
comparing at least a portion of the ad campaign information associated with the ad campaigns with at least a portion of ad campaign information associated with the ad campaign.

13. The method as recited in claim 1, further comprising:
modifying a format of the ad campaign information associated with the campaigns to generate modified ad campaign information;
wherein applying natural language processing (NLP) to at least a portion of the ad campaign information associated with ad campaigns previously booked by the online publisher includes applying NLP to at least a portion of the modified ad campaign information associated with the ad campaigns previously booked by the online publisher.

14. The method as recited in claim 13, wherein the modified ad campaign information associated with each of the ad campaigns includes a set of words, the method further comprising:
assigning weights to one or more of the set of words in the modified ad campaign information such that the modified ad campaign information includes the weights.

15. The method as recited in claim 1, wherein processing ad campaign information associated with ad campaigns previously booked by an online publisher to identify one or more of the ad campaigns previously booked by the online publisher that are similar to the ad campaign comprises:
applying probabilistic latent semantic indexing (PLSI) to at least a portion of the ad campaign information associated with the ad campaigns.

16. The method as recited in claim 1, wherein processing ad campaign information associated with ad campaigns previously booked by an online publisher to identify one or more of the ad campaigns previously booked by the online publisher that are similar to the ad campaign comprises:
performing nearest neighbor searching to identify the one or more of the ad campaigns previously booked by the online publisher that are similar to the ad campaign.

17. The method as recited in claim 1, wherein the ad campaigns have been booked by a plurality of advertisers.

18. The method as recited in claim 17, wherein the plurality of advertisers include the advertiser.

19. An apparatus, comprising:
a processor; and
a memory, at least one of the processor or the memory being adapted for:
identifying an ad campaign associated with an advertiser;
processing ad campaign information associated with ad campaigns previously booked by an online publisher to identify one or more of the ad campaigns previously booked by the online publisher that are similar to the ad campaign, wherein the ad campaigns previously booked by the online publisher include the ad campaign associated with the advertiser, the ad campaign information for each of the ad campaigns and the ad campaign identifying one or more products of the online publisher, wherein processing the ad campaign information includes applying natural language processing (NLP) to at least a portion of the ad campaign information associated with the ad campaigns previously booked by the online publisher; and
ascertaining information indicating effectiveness of the ad campaign using the ad campaign information for the one or more ad campaigns previously booked by the online publisher that are similar to the ad campaign and the ad campaign information for the ad campaign.

20. The apparatus as recited in claim 19, wherein the ascertained information indicates at least one of the products of the online publisher to recommend to the advertiser.

21. The apparatus as recited in claim 19, wherein processing the ad campaign information further comprises:
generating modified ad campaign information from the ad campaign information for each of the ad campaigns, the modified ad campaign information including a set of words and corresponding weights; and
applying the NLP to the modified campaign information for the ad campaigns to identify the one or more of the ad campaigns previously booked by the online publisher that are similar to the ad campaign.

22. The apparatus as recited in claim 21, wherein the set of words does not include numerical values.

23. The apparatus as recited in claim 21, wherein the set of words does not include acronyms.

24. A computer-readable medium storing thereon computer-readable instructions, comprising:
instructions for identifying an ad campaign associated with an advertiser as a seed campaign;
instructions for processing ad campaign information associated with ad campaigns previously booked by an online publisher to identify one or more of the ad campaigns previously booked by the online publisher that are similar to the seed campaign, the ad campaign information for each of the ad campaigns identifying one or more products of the online publisher, wherein processing the ad campaign information includes applying natural language processing (NLP) to at least a portion of the ad campaign information associated with the ad campaigns previously booked by the online publisher; and
instructions for identifying one or more products to recommend to the advertiser based upon the ad campaign information for the one or more ad campaigns previously booked by the online publisher that are similar to the ad campaign.

25. The computer-readable medium as recited in claim 24, further comprising:
instructions for identifying one or more products of the online publisher that have been implemented in the similar campaigns; and
instructions for generating the one or more products to recommend to the advertiser from one or more components of the identified products.

26. A method, comprising:
identifying an ad campaign associated with an advertiser as a seed campaign;
processing ad campaign information associated with ad campaigns previously booked by an online publisher to identify one or more of the ad campaigns previously booked by the online publisher that are similar to the seed campaign, the ad campaign information for each of the ad campaigns identifying one or more products of the online publisher, wherein the ad campaign information indicates one or more product features of each of the products, wherein processing the ad campaign information includes applying natural language processing (NLP) to at least a portion of the ad campaign information associated with the ad campaigns previously booked by the online publisher; and
ascertaining from the ad campaign information for the one or more ad campaigns previously booked by the online publisher that are similar to the ad campaign at least one of the product features from the similar campaigns to recommend to the advertiser.
